(19) United States
(12) Patent Application Publication
(10) Pub. No.: US 2015/0269291 A1
(43) Pub. Date: Sep. 24, 2015

(54) DATA PROCESSING APPARATUS AND DATA PROCESSING PROGRAM

(71) Applicant: KABUSHIKI KAISHA TOSHIBA, Tokyo (JP)

(72) Inventors: Masahiro SEKINE, Tokyo (JP); Kaoru SUGITA, Tokyo (JP); Masashi NISHIYAMA, Kawasaki (JP)

(21) Appl. No.: 14/641,570

(22) Filed: Mar. 9, 2015

(30) Foreign Application Priority Data
Mar. 24, 2014 (JP) 2014-060026

(51) Int. Cl. G06F 17/50; G06F 17/10

(52) U.S. Cl. CPC G06F 17/5009; G06F 17/10

(57) ABSTRACT

A data processing apparatus according to an embodiment includes a control-point calculating unit and a deformation processing unit. The control-point calculating unit calculates target position coordinates on the basis of a first model representing a shape of a first object, deformation parameters representing characteristics of deformation of the first object, and a second model representing a shape of a second object. The target position coordinates are the coordinates to which points of the first model should move according to the second model when the first object is deformed according to the second object. The deformation processing unit calculates reaching position coordinates to minimize a sum of absolute values of differences between the target position coordinates and the reaching position coordinates where the point reaches. The sum is obtained by taking into account importance levels of the points.

### CROSS-REFERENCE TO RELATED APPLICATIONS

This application is based upon and claims the benefit of priority from Japanese Patent Application No. 2014-060026, filed on Mar. 24, 2014; the entire contents of which are incorporated herein by reference.

### FIELD

Embodiments described herein relate generally to a data processing apparatus and data processing program.

### BACKGROUND

In recent years, according to the progress of a sensing technique for a real object and a rendering technique for CG (computer graphics), applications for performing simulations of various scenes through visualization representation called VR (Virtual Reality) or AR (Augmented Reality) have appeared. Examples of the applications include a virtual fitting simulation and a virtual setting simulation.

In the virtual fitting simulation, a body shape and a posture of a human body is sensed from a real video to generate a human body model. A garment model is deformed and combined with the human body model according to the shape of the human body model. Consequently, a person can have virtual experience as if the person actually tries on a garment. In the virtual setting simulation, furniture or bedding such as a table or a bed is sensed from a real video to generate a furniture or bedding model. A model of a tablecloth, a sheet, or the like is deformed and combined with the furniture or bedding model according to the shape of the furniture or bedding model. Consequently, a person can have virtual experience as if the person actually changes an interior of a room. When both of an object to be combined (the human body, the table, the bed, or the like) and a combining object (the garment, the tablecloth, the sheet, or the like) are visualized by the CG, VR representation is realized. When the object to be combined is actually filmed and the combining object is visualized by the CG, AR representation is realized.

In such applications, a technique for virtually deforming the model of the combining object according to a model shape of the object to be combined is necessary. Examples of a method of deforming a model include a method of deforming the model according to a physical simulation taking into account a mechanical characteristic of the combining object, the gravity, and the like and a method of assuming a plurality of kinds of the objects to be combined in advance, calculating deformation that occurs when the combining object is matched to the objects to be combined, accumulating results of the calculation, and, when the object to be combined actually appears, selecting a calculation result closest to the real object to be combined.

However, the method by the physical simulation requires a lot of computer resources and a long calculation time. The method of accumulating the calculation results in advance requires vast simulations beforehand and uses a calculation result obtained by using the objects to be combined different from the real object to be combined. Therefore, accuracy of the calculation tends to be deteriorated.

### BRIEF DESCRIPTION OF THE DRAWINGS

FIG. 1 is a block diagram illustrating a data processing apparatus according to a first embodiment;

FIG. 2 is a diagram schematically illustrating a change of data in a data processing method according to the first embodiment;

FIG. 3 is a flowchart illustrating the data processing method according to the first embodiment;

FIG. 4 is a diagram illustrating a garment model in the first embodiment;

FIG. 5 is a diagram illustrating control weight information of a texture format;

FIG. 6 is a diagram illustrating designation of gap information as an absolute value;

FIG. 7 is a diagram illustrating designation of the gap information as a relative value;

FIG. 8 is a diagram illustrating a human body model;

FIG. 9 is a block diagram illustrating a data processing apparatus according to a second embodiment;

FIG. 10A is a diagram illustrating a deformation history at time (t−1); FIG. 10B is a diagram illustrating a control-point calculating method at time t;

FIG. 11 is a time chart illustrating a data processing method according to the second embodiment; and

FIG. 12 is a flowchart illustrating the data processing method according to the second embodiment.

### DETAILED DESCRIPTION

A data processing apparatus according to an embodiment includes a control-point calculating unit and a deformation processing unit. The control-point calculating unit calculates target position coordinates on the basis of a first model representing a shape of a first object, deformation parameters representing characteristics of deformation of the first object, and a second model representing a shape of a second object. The target position coordinates are the coordinates to which points of the first model should move according to the second model when the first object is deformed according to the second object. The deformation processing unit calculates reaching position coordinates to minimize a sum of absolute values of differences between the target position coordinates and the reaching position coordinates where the point reaches. The sum is obtained by taking into account importance levels of the points.

### First Embodiment

Embodiments of the present invention are described below with reference to the drawings.

First, a first embodiment is described.

In the embodiment, a series of data processing for deforming a model of a combining object (a first object) according to the shape of an object to be combined (a second object) is specifically described. In the following explanation, an example of the object to be combined is a human body and an example of the combining object is a garment. In particular, contents of deformation parameters and a method of using the deformation parameters are described in detail.

### <<Data Processing Apparatus>>

A data processing apparatus according to the embodiment is a data processing apparatus that simulates a shape after deformation of a combining object deformed according to an object to be combined when the combining object is applied to the object to be combined. More specifically, the data processing apparatus is an apparatus that simulates deformation of a garment when the garment is virtually worn on a human body. In the specification, “the combining object is applied to the object to be combined” means deforming the shape of the combining object to fit the shape of the object to be combined and is, for example, a concept including “the garment is worn on the human body”.

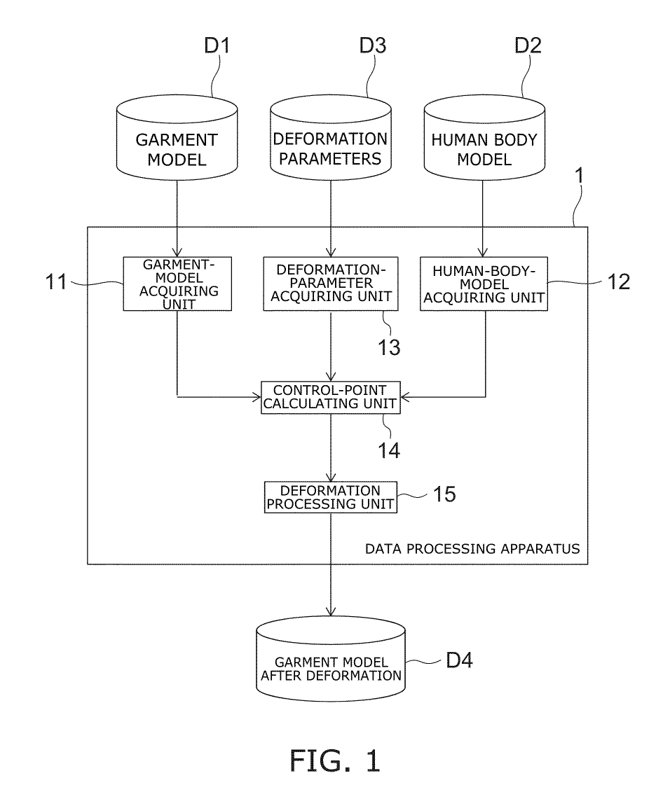

FIG. 1 is a block diagram illustrating the data processing apparatus according to the embodiment.

As shown in FIG. 1, a data processing apparatus 1 according to the embodiment includes a garment-model acquiring unit 11, a human-body-model acquiring unit 12, a deformation-parameter acquiring unit 13, a control-point calculating unit 14, and a deformation processing unit 15.

A garment model D1, which is a combining model (a first model), a human body model D2, which is a model to be combined (a second model), and deformation parameters D3 of the garment model are input to the data processing apparatus 1. The garment model D1 is data representing the shape of the garment, which are the combining object. The deformation parameters D3 are data representing characteristics of deformation of the garment. The human body model D2 is data representing the shape of the human body, which is the object to be combined. Details of the garment model D1, the human body model D2, and the deformation parameters D3 are described below.

The garment-model acquiring unit 11 acquires the garment model D1 from the outside of the data processing apparatus 1. The human-body-model acquiring unit 12 acquires the human body model D2 from the outside of the data processing apparatus 1. The deformation-parameter acquiring unit 13 acquires the deformation parameters D3 from the outside of the data processing apparatus 1.

The control-point calculating unit 14 calculates, on the basis of the garment model D1, the human body model D2, and the deformation parameters D3, target position coordinates to which points of the garment model D1 should move according to the human body model D2 when the garment is worn on the human body.

The deformation processing unit 15 calculates reaching position coordinates to minimize a sum of absolute values of differences between target position coordinates of the points of the garment model D1 and reaching position coordinates where the points actually reach, i.e., a sum obtained by taking into account importance levels of the points. The deformation of the garment is limited by a relation among points of the garment, an allowable amount of extension and contraction of a material of the garment, and the like. Therefore, the reaching position coordinates of the points in the garment model after the deformation are likely to be different from the target position coordinates. Through the processing described above, it is possible to simulate how the garment model D1 is deformed as a whole.

The data processing apparatus 1 can be realized by, for example, dedicated hardware. In this case, the garment-model acquiring unit 11, the human-body-model acquiring unit 12, the deformation-parameter acquiring unit 13, the control-point calculating unit 14, and the deformation processing unit 15 may be configured separately from one another.

The data processing apparatus 1 may be realized by causing a general-purpose personal computer to execute a computer program. In this case, the garment-model acquiring unit 11, the human-body-model acquiring unit 12, and the deformation-parameter acquiring unit 13 may be realized by cooperation of, for example, an optical drive, a LAN (Local Area Network) terminal or a USB (Universal Serial Bus) terminal, a CPU (central processing unit), and a RAM (Random Access Memory). The control-point calculating unit 14 and the deformation processing unit 15 may be realized by a CPU and a RAM.

### <<Data Processing Method>>

The operation of the data processing apparatus 1, that is, a data processing method according to the embodiment is described.

### <Overview of the Data Processing Method>

First, an overview of the data processing method is described together with a method of creating the garment model D1, the human body model D2, and the deformation parameters D3 used in data processing.

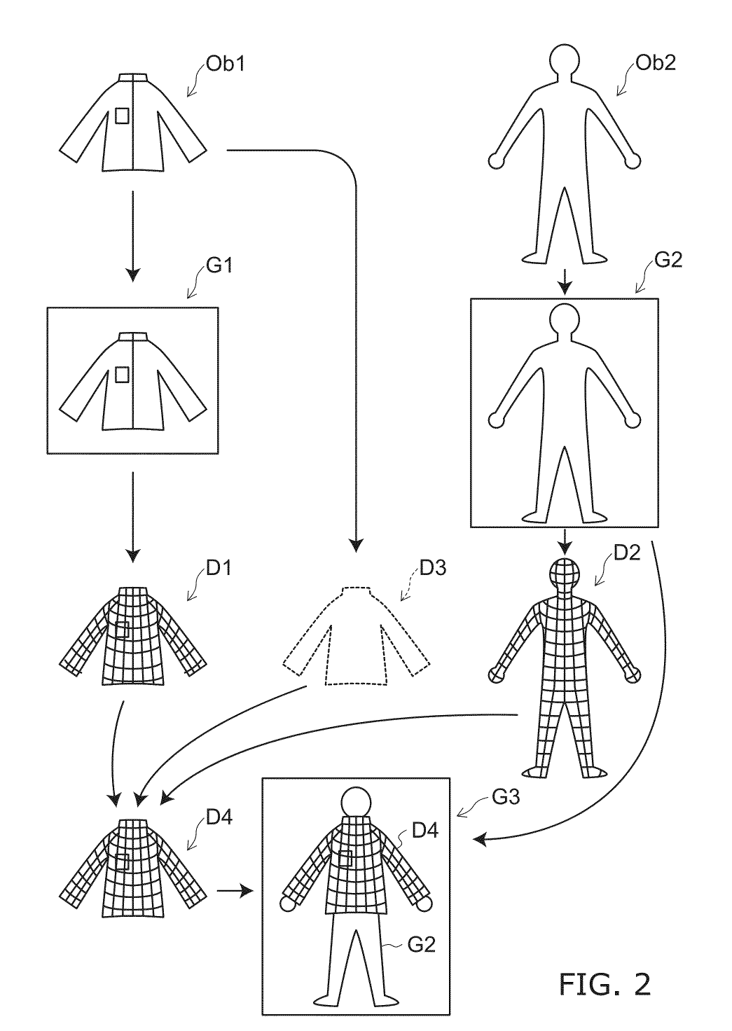

FIG. 2 is a diagram schematically illustrating a change of data in the data processing method according to the embodiment.

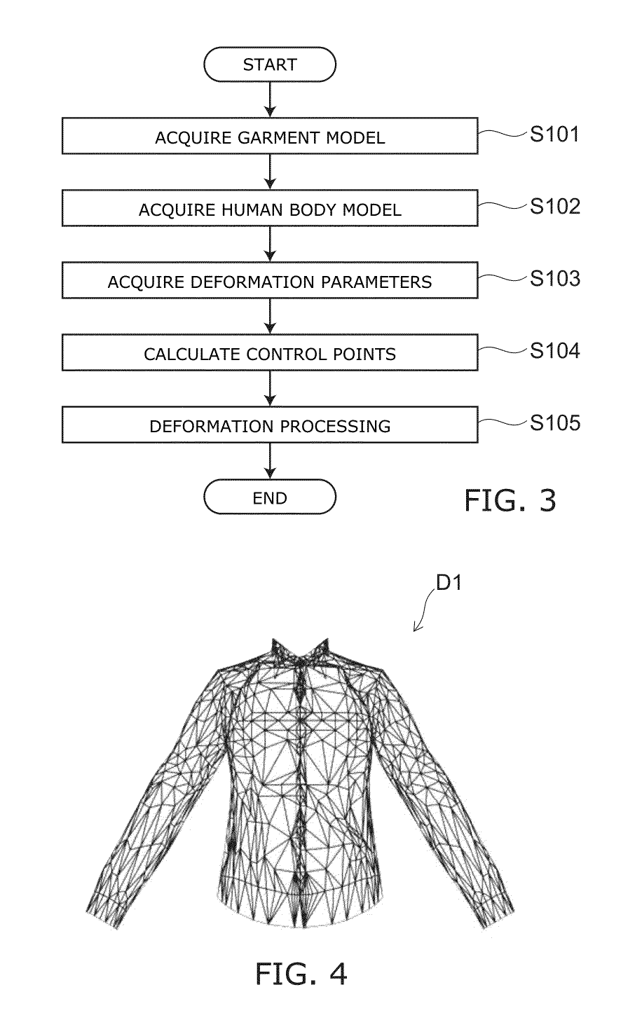

FIG. 3 is a flowchart illustrating the data processing method according to the embodiment.

As shown in FIG. 2, the data processing method according to the embodiment is a method of simulating deformation of a garment Ob1, which is a combining object that occurs when the garment Ob1 is virtually worn on a human body Ob2, which is an object to be combined.

Prior to the data processing, the garment model D1 representing the shape of the garment Ob1 is created. The garment model D1 is created by, for example, an operator using CG modeling software, CAD software, or the like. It is also possible to photograph the garment Ob1 with photographing means attached with a depth sensor such as a camera or an infrared camera to acquire the garment image G1 and create the garment model D1 with the CG modeling software, the CAD software, or the like on the basis of the garment image G1. The garment model D1 may be automatically generated by estimating a three-dimensional structure from depth data. The deformation parameters D3 representing characteristics of deformation of the garment model D1 are created from the garment Ob1.

On the other hand, the human body Ob2 is photographed by the photographing means attached with the depth sensor to acquire a human body image G2. The human body model D2 representing the shape of the human body Ob2 is generated on the basis of the human body image G2.

As shown in step S101 in FIG. 3, the garment-model acquiring unit 11 of the data processing apparatus 1 acquires the garment model D1.

Subsequently, as shown in step S102, the human-body-model acquiring unit 12 acquires the human body model D2.

As shown in step S103, the deformation-parameter acquiring unit 13 acquires the deformation parameters D3.

As shown in step S104, the control-point calculating unit 14 calculates, on the basis of the garment model D1, the deformation parameters D3, and the human body model D2, target position coordinates, which are positions to which points of the garment model D1 should move according to the human body model D2 when the garment is deformed according to the human body by putting the garment on the human body.

As shown in step S105, the deformation processing unit 15 calculates reaching position coordinates of the points of the garment model after the deformation. The deformation processing unit 15 adjusts the reaching position coordinates to minimize a sum of absolute values of differences between the target position coordinates and the reaching position coordinates, i.e., a sum obtained by taking into account importance levels of the points of the garment model D1.

Consequently, a garment model D4 after the deformation is obtained. As described below, at least a part of a calculation result that can be calculated on the basis of the garment model D1 and the deformation parameters D3 in a calculation formula used for a simulation is calculated and included in the deformation parameters D3 in advance. Consequently, it is possible to realize the simulation at high speed.

Thereafter, a combined image G3 can be created by superimposing the garment model D4 after the deformation on the human body image G2. In the embodiment, processing for the superimposing is performed on the outside of the data processing apparatus 1.

### <Details of the Data Processing Method>

Details of the data processing method according to the embodiment are described in detail.

First, data used in the embodiment, that is, the garment model D1, the deformation parameters D3, and the human body model D2 are described.

### <Garment Model>

First, the garment model D1 is described.

FIG. 4 is a diagram illustrating the garment model in the embodiment.

As shown in FIG. 4, the garment model D1, which is a combining model to be deformed, is configured by data of computer graphics. In the garment model D1, a plurality of polygon data representing the shape of the garment are configured by a vertex coordinate list indicating three-dimensional position coordinates of a plurality of vertexes and a vertex index list indicating which vertexes are used to form a polygon. Crossing points of a lattice shown in FIG. 4 are the vertexes.

The garment model D1 may be configured by only a vertex coordinate list, which takes into account order of forming polygons, without using the vertex index list. As data incidental to the model data, normal vectors of the vertexes and the polygons may be included in advance or may be calculated in the data processing apparatus 1. Further, when the deformation parameters D3 are given as texture data, texture coordinates for associating the texture data with the vertexes may be included.

### <Deformation Parameters>

The deformation parameters D3 are described.

In the deformation parameters D3, for example, control weight information, corresponding position information, gap information, and deforming flexibility information are included. In the deformation parameters D3, only a part of the information may be included or information other than the information may be included.

### <Control Weight Information>

The control weight information is information indicating, when the garment model D1 is deformed with respect to the vertexes of the garment model D1, at which importance level the garment model D1 should be controlled. As the control weight information, a true value (true/false or 1/0) indicating whether a certain vertex is set as a control point or a value (a value between 0.0 and 1.0) of weight indicating an importance level of control is designated.

Specifically, ornamental parts such as a collar, a pocket, and a button of the garment model D1 should not be deformed according to the shape of the human body model D2 and should be deformed according to deformation of the other parts of the garment model D1. Therefore, the ornamental parts are not set as control points. Therefore, as the control weight information, 0 or a value close to 0 is set. On the other hand, the shoulders and an upper part of the back of the garment model D1 should be relatively strictly deformed according to the shape of the human body model. Therefore, the shoulders and the upper part of the back are set as control points having high importance levels. Therefore, as the control weight information, 1 or a value close to 1 is set. The sides and a lower part of the back of the garment model D1 are portions that are deformed according to the shape of the human body but may be deformed with a certain degree of freedom. Therefore, the sides and the lower part of the back are set as control points having low importance levels. Therefore, as the control weight information, an intermediate value such as 0.4 or 0.6 is set.

In general, in the combining object, values of the control weight information are set relatively high for structural parts and values of the control weight information are set relatively low for ornamental parts. In the structural parts, values of the control weight information are set higher for portions closely attached to the object to be combined by the action of the gravity or the like.

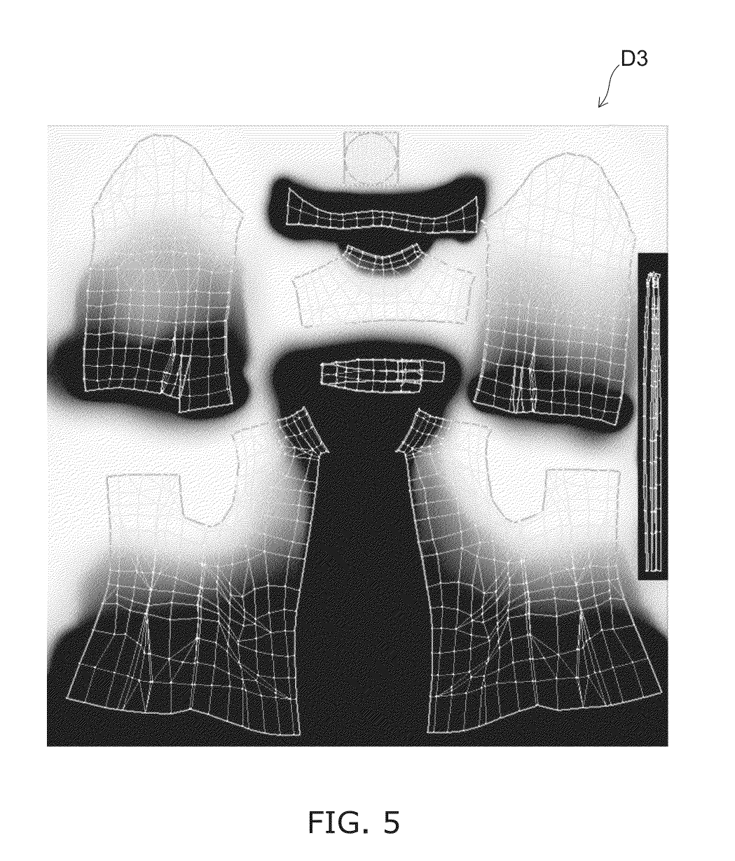

FIG. 5 is a diagram illustrating control weight information of a texture format.

In FIG. 5, the garment model D1 is disassembled into parts of the garment. Values of the control weight information of portions of the parts are indicated by gradation. That is, in dark gray regions, the control weight information is 1 or a value close to 1. In light gray regions, the control weight information is an intermediate value. In white regions, the control weight information is 0 or a value close to 0.

### <Corresponding Position Information>

The corresponding position information is information representing positions on the human body model D2 corresponding to the vertexes on the garment model D1. For example, the human body model is divided into a plurality of parts, for example, the forehead part, the head top part, the head side part, the head back part, the neck, the right shoulder, the left shoulder, the right upper arm, the left upper arm, the right forearm, the left forearm, the right hand, the left hand, the chest, the back, the belly, the waist, the right thigh, the left thigh, the right lower leg, the left lower leg, the right foot, and the left foot. Part IDs are attached to the parts. The part IDs are recorded as attributes of the vertexes of the garment model D1.

Consequently, when the garment model D1 is matched to the human body model D2, for example, a portion around the neck of the garment model D1 is associated with the neck part of the human body model D2. A portion of the sleeve of the right upper arm of the garment model D1 is associated with the part of the right upper arm of the human body model D2. As a result, it is possible to prevent a great mistake of a matching position and reduce computational complexity of a simulation.

The part IDs do not need to be associated with all the vertexes of the garment model D1 and may be associated with only a part of the vertexes, for example, only the vertexes where values of the control weight information are large. As the corresponding position information, corresponding part weight indicating priority for searching for a corresponding position of each of part IDs of the human body model D2 may be used. Corresponding point weight indicating priority for searching for corresponding positions in the vertexes of the human body model D2 may be used. Further, not only the part IDs corresponding to the parts of the human body but also IDs in finer units may be used. For example, IDs corresponding to a single polygon or a group consisting of a plurality of polygons of the garment model D1 may be used.

### <Gap Information>

The gap information is information representing setting values of distances between the points of the garment model D1 and the human body model D2 and is information indicating, concerning the control points of the garment model D1, how large gap is provided with respect to the human body model D2 to set the control points as target positions after deformation. The gap information is spacing amounts indicating distances by which target positions of the control points after deformation of the garment model D1 are spaced from the surface of the human body model in the normal direction of the human body model. The gap information describes the spacing amount as an absolute value or a relative value.

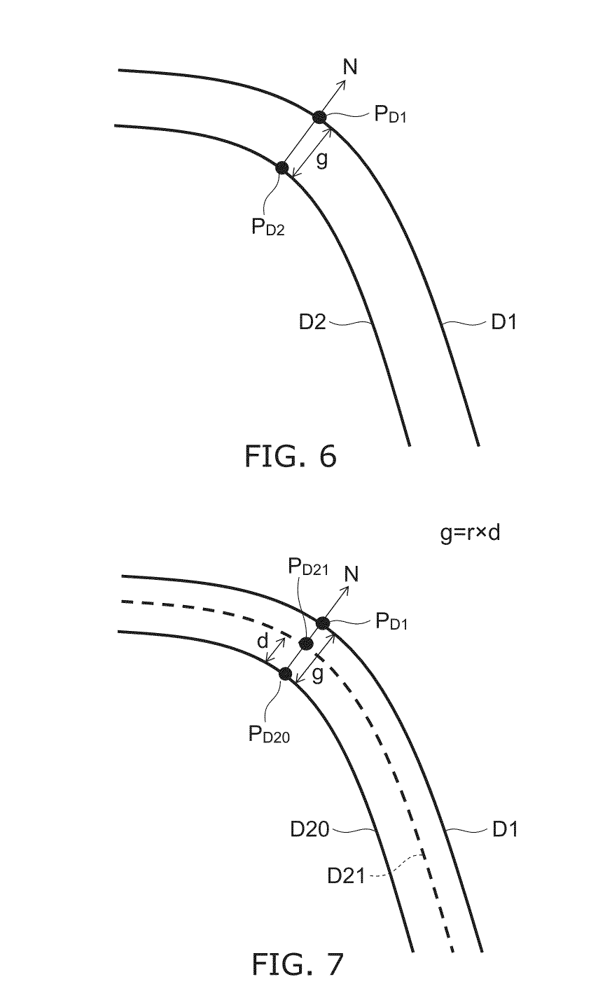

FIG. 6 is a diagram illustrating designation of the gap information as an absolute value.

As shown in FIG. 6, in this case, a target position of a control point P_{D1} on the garment model D1 is a position spaced from a corresponding point P_{D2} of the human body model D2 by a distance g along a normal direction N of the corresponding point P_{D2}.

FIG. 7 is a diagram illustrating designation of the gap information as a relative value.

As shown in FIG. 7, in this case, two kinds of human body models are prepared. For example, rather than the garment Ob1 indicated by the garment model D1, an inner garment worn on the inner side of the garment Ob1 is assumed. A human body model D20 not wearing the inner garment and a human body model D21 wearing the inner garment are prepared. A distance d between a corresponding point P_{D20} of the human body model D20 corresponding to the control point P_{D1} of the garment model D1 and a corresponding point P_{D21} of the human body model D21 is calculated. The distance g between the control point P_{D1} of the garment model D1 and the corresponding point P_{D20} of the human body model D20 has a fixed relation between the distance g and the distance d and can be represented as, for example, g=r×d. The coefficient r is gap information of a control point P_{D3}.

When the gap information is set, a region of the garment and a type of the garment are taken into account.

When the gap information is set taking into account a region of the garment, in general, the distance g is set relatively short concerning a portion of the combining object (e.g., a garment) disposed above the object to be combined (e.g., a human body). The distance g is set relatively long concerning a portion disposed on a side of or below the object to be combined. For example, the distance g is set relatively short for the parts of the shoulders and the back of the garment model such that the parts are closely attached to the human body model. The distance g is set relatively long for the parts such as the arms and the sides of the garment model such that the garment model is loosely worn on the human body model.

On the other hand, when the gap information is set taking into account the type of the garment, for example, when there are a plurality of types as the combining object and the combining object is applied to be superimposed on the object to be combined, the distance g is set shorter for the combining object disposed in a position closer to the object to be combined. For example, the distance g is set taking into account a type of the garment such as a T-shirt, a dress shirt, a sweater, a jacket, or a coat, on the basis of the order of layered wearing, and taking into account thickness from the human body model. Specifically, the distance g of the T-shirt or the dress shirt is set relatively short such that the T-shirt or the dress shirt is closely attached to the human body model. The distance g of the sweater is set longer than the distance g of the T-shirt or the dress shirt taking into account that the sweater is worn over the T-shirt or the dress shirt. The distance g of the jacket or the coat is set longer than the distances g of the T-shirt, the dress shirt, and the sweater taking into account that the jacket or the coat is worn over the T-shirt, the dress shirt, and or sweater.

### <Deforming Flexibility Information>

The deforming flexibility information is information representing a mechanical characteristic of the garment. The deforming flexibility information is set, for example according to softness and a degree of expansion and contraction of a material of the garment model. The deforming flexibility information designates an allowable range of a change vector or a change amount before and after deformation among vertexes adjacent to one another in the vertexes on the garment model. Specifically, in the case of a material easily distorted or expanded and contracted like a sweater, the allowable range of the change vector or the change amount is set large. In the case of a material less easily distorted or expanded and contracted like leather, the allowable range of the change vector or the change amount is set small.

The deformation parameters D3 are allocated to the vertexes of the garment model D1. The deformation parameters corresponding to the vertexes of the garment model D1 may be retained as numerical value data corresponding to the vertexes like normal vectors or may be retained as the texture format shown in FIG. 5. When the deformation parameters are given as texture data, texture coordinates need to be set in the garment model D1. The deformation parameters can be associated with the vertexes of the garment model by performing texture mapping on the basis of the texture coordinates set in the garment model. Various kinds of information included in the deformation parameters may be embedded in a single texture as data or may be embedded in separate textures as data.

### <Human Body Model>

The human body model is a model used as a reference for deforming the garment model D1 and configured by data of computer graphics.

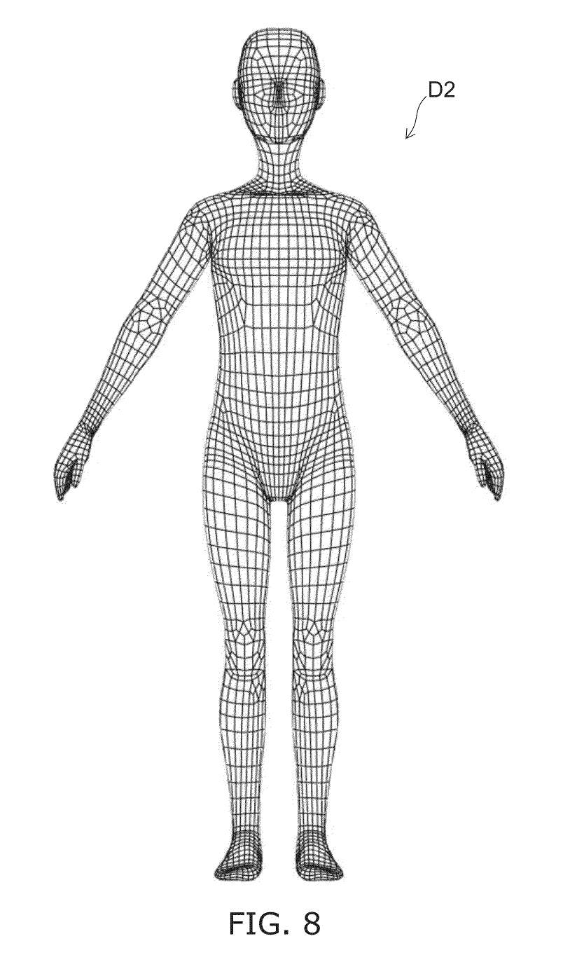

FIG. 8 is a diagram illustrating the human body model.

As shown in FIG. 8, the human body model D2 is configured by a vertex coordinate list indicating three-dimensional position coordinates concerning a plurality of vertexes of a plurality of polygons representing the shape of a human body and a vertex index list indicating which vertexes are used to form a polygon. Crossing points of a lattice shown in FIG. 8 are the vertexes. As described above, the part IDs allocated to each of regions are given to the human body model D2. Further, as described above, when the gap information is given as a relative value, concerning the same human body, two kinds of human body models are prepared, i.e., the human body model D20 not wearing an inner garment and the human body model D21 wearing the inner garment.

The human body model D2 may be configured by only the vertex coordinate list, which takes into account order of forming polygons, without using the vertex index list. As data incidental to the data, normal vectors of the vertexes or the polygons may be included. The normal vectors may be calculated after being input to the data processing apparatus 1.

### <Idea of Data Processing>

An idea of the calculation of the control points in step S104 and the deformation processing in step S105 is described. In step S104, considering an energy function indicated by Expression 1, a formula for calculating a solution for minimizing energy of the energy function is set up. In step S105, the formula is solved to simulate deformation of a garment.

In Expression 1, E represents the energy function, m represents the number of vertexes set as control points among vertexes of a garment model, cᵢ represents a target position coordinate after deformation of an i-th control point, xᵢ represents a reaching position coordinate after the deformation of the i-th control point, and λᵢ represents control weight information representing an importance level of control of the i-th control point. The energy function E is obtained by weighting a square of a difference between a target position coordinate and a reaching position coordinate with respect to all the control points and totaling the squares. The target position coordinate cᵢ is determined on the basis of the human body model D2, the gap information, and the corresponding position information. Therefore, Expression 1 includes the human body model D2 and the control weight information, the gap information, and the corresponding position information among the deformation parameters D3.

In data processing described below, the reaching position coordinate xᵢ is calculated such that the energy function E is minimized, that is, the garment model D1 fits in an ideal position determined on the basis of the human body model D2 as much as possible.

$$E = {\sum }_{i = 0}^{m} {λ}_{i} {‖ {x}_{i} - {c}_{i} ‖}^{2} \qquad Expression 1$$

Determinants shown in Expressions 2 to 4 are solved in order to calculate the reaching position coordinate xᵢ for minimizing the energy function E shown in Expression 1. In Expression 2, the number of rows of a matrix A is equivalent to the number of control points of the garment model and the number of columns is equivalent to the number of vertexes of the garment model. The number of control points is, for example, approximately 3000. In Expression 3, the number of rows of a matrix b is equivalent to the number of control points of the garment model.

$$\begin{matrix}A = [ \begin{matrix}{λ}_{0} & 0 & 0 & … & 0 & 0 \\ ⋮ & ⋮ & ⋮ & ⋱ & ⋮ & ⋮ \\ 0 & 0 & 0 & … & {λ}_{m - 1} & 0\end{matrix} ] & Expression 2 \\ b = [ \begin{matrix}{λ}_{0} {c}_{0} \\ ⋮ \\ {λ}_{m - 1} {c}_{m - 1}\end{matrix} ] & Expression 3 \\ ( {A}^{T} A ) x = {A}^{T} b & Expression 4\end{matrix}$$

When Expression 4 is solved with respect to the reaching position coordinate xᵢ, Expression 5 is obtained. To calculate the reaching position coordinate xᵢ, an arithmetic operation shown in Expression 5 only has to be performed.

x=(A^{T}A)⁻¹A^{T}b Expression 5

To perform the arithmetic operation shown in Expression 5, it is necessary to calculate an inverse matrix of a large matrix such as (A^{T}A)⁻¹. Since the matrix A is a symmetric positive definite matrix, it is possible to calculate the inverse matrix at relatively high speed by using a method called singular value decomposition or Cholesky decomposition. However, if the inverse matrix is calculated every time the processing is executed, a processing time is long.

### <Effects of the Control Weight Information>

Therefore, it is effective for an increase in speed of the processing to determine beforehand the control weight information for determining beforehand which vertexes of parameters concerning the matrix A, in particular, the garment model are set as control points and with which importance level the control points are controlled. If the matrix A is determined beforehand, a portion that can be determined by only information of the matrix Z in Expression 5, that is, a matrix (A^{T}A)⁻¹A^{T} can be calculated beforehand and a result of the calculation can be retained as a part of the deformation parameters D3. Therefore, it is possible to markedly reduce the processing time during the execution. That is, by including the control weight information in the deformation parameters D3, when the reaching position matrix Xᵢ for minimizing the energy function E in Expression 1 and Expression 6 is calculated, it is possible to determine whether the vertexes of the garment model D1 should be included in the control points and, if the vertexes are included in the control points, what kind of value λᵢ should be set to.

### <Effects of the Corresponding Position Information and the Gap Information>

In the matrix b, it is important whether the target position coordinate cᵢ can be calculated at high speed and high accuracy during the execution. The target position coordinate cᵢ after deformation of the i-th control point is calculated with reference to a point on the human body model corresponding thereto. Therefore, it is important to calculate the corresponding point on the human body model at high speed and high accuracy.

Determination concerning a position shifted by which length and in which direction from the corresponding point on the human body model is set as the target position coordinate greatly affects the quality of the garment model after the deformation. Therefore, because of the presence of the corresponding position information, when the target position coordinate cᵢ is set in Expression 1 or Expression 6, it is possible to determine at high speed and high accuracy to which positions of the human body model D2 the control points of the garment model D1 correspond. Therefore, by including the gap information in the deformation parameters D3, it is possible to set the target position coordinate cᵢ at high accuracy in Expression 1 or Expression 6.

Only an energy term related to the movement of the control points is described above. However, when the garment model is actually deformed using such an energy function, vertexes not set as the control points remain in the original positions or the shape of the garment represented by the garment model is distorted. Therefore, for example, an energy term for maintaining a positional relation among vertexes adjacent to one another like a method called Laplacian mesh deformation is added as indicated by Expression 6. In Expression 6, n represents the number of vertexes of the garment model and μⱼ represents weight for indicating an importance level for maintaining a positional relation among vertexes adjacent to a j-th vertex. L represents Laplacian and is vector representation of the positional relation among the adjacent vertexes.

$$E = {\sum }_{i = 0}^{m} {λ}_{i} {‖ {x}_{i} - {c}_{i} ‖}^{2} + {\sum }_{j = 0}^{n} {μ}_{j} {‖ L ( {x}_{f} ) - L ( {p}_{j} ) ‖}^{2} \qquad Expression 6$$

The Laplacian L shown in Expression 6 can be calculated as indicated by Expression 7 and Expression 8. In Expression 7 and Expression 8, e represents a set of vertexes connected to a vertex vⱼ by edges and ωⱼₖ represents weight at a vertex vₖ adjacent to the vertex vⱼ. L(pⱼ) represents Laplacian of the garment model before the deformation and L(xⱼ) represents Laplacian of the garment model after the deformation desired to be finally calculated.

$$\begin{matrix}L ( {v}_{j} ) = {v}_{j} - {\sum }_{( {v}_{j} , {v}_{k} ) ∈ e} {ω}_{jk} {v}_{k} & Expression 7 \\ {\sum }_{( {v}_{j} , {v}_{k} ) ∈ e} {ω}_{jk} = 1 & Expression 8\end{matrix}$$

As indicated by Expression 7 and Expression 8, when an energy term is added, a determinant for calculating a minimum value of an energy function is represented as indicated by Expression 9 and Expression 10.

$$\begin{matrix}A = [ \begin{matrix}{λ}_{0} & 0 & 0 & … & 0 & 0 \\ ⋮ & ⋮ & ⋮ & ⋱ & ⋮ & ⋮ \\ 0 & 0 & 0 & … & {λ}_{m - 1} & 0 \\ {μ}_{0} & - {μ}_{0} {ω}_{01} & - {μ}_{0} {ω}_{02} & … & 0 & 0 \\ ⋮ & ⋮ & ⋮ & ⋱ & ⋮ & ⋮ \\ 0 & 0 & 0 & … & - {μ}_{n - 1} {ω}_{( N - 1 ) ( N - 2 )} & {μ}_{n - 1}\end{matrix} ] & Expression 9 \\ b = [ \begin{matrix}{λ}_{0} {c}_{0} \\ ⋮ \\ {λ}_{m - 1} {c}_{m - 1} \\ {μ}_{0} L ( {p}_{0} ) \\ ⋮ \\ {μ}_{n - 1} L ( {p}_{n - 1} )\end{matrix} ] & Expression 10\end{matrix}$$

In the matrix A, the number of rows is equivalent to a sum of the number of control points and the number of vertexes on the garment model. The number of columns is equivalent to the number of vertexes on the garment model. In the matrix b, the number of rows is equivalent to the sum of the number of control points and the number of vertexes on the garment model. When the energy term is added, the matrix is increased in size by the energy term. Therefore, the effect of the prior calculation increases.

### <Effects of the Deforming Flexibility Information>

In Expression 10, μⱼ represents weight for indicating an importance level for maintaining the positional relation among the vertexes adjacent to the j-th vertex. In particular, in the case of the garment model, there are a portion that may be deformed and a portion that should not be deformed are present according to a material of the garment. By acquiring such parameters in advance, it is possible to simulate the deformation of the garment model at higher accuracy. That is, the deforming flexibility information is reflected on the μⱼ shown in Expression 10.

By including the deforming flexibility information in the deformation parameters D3 in this way, it is possible to calculate the weight μⱼ at high accuracy in Expression 6. For example, when an allowable range of a change amount (expansion and contraction) before and after deformation between the vertex vⱼ and the vertex vₖ adjacent thereto is represented as sₖ, the importance level μⱼ for maintaining a positional relation among vertexes adjacent to the vertex vⱼ can be calculated by Expression 11. In Expression 11, l represents the number of adjacent vertexes and S represents a threshold for setting the importance level μⱼ to 1 with respect to an average in the allowable range sₖ of expansion and contraction. When the denominator of the right side of Expression 11 is 0 and when μⱼ on the left side is not less than 1, μⱼ=1.

$${μ}_{j} = \frac{Sl}{{\sum }_{( {v}_{j} , {v}_{k} )} ∈ {e}^{{S}_{k}}} \qquad Expression 11$$

### <Control-Point Calculating Unit>

In view of the processing contents described above, the control-point calculating unit 14 is described in detail.

As described above, the control-point calculating unit 14 substitutes the values in the energy function shown in Expression 1 or Expression 6 and sets up a formula for calculating the reaching position coordinate xᵢ for minimizing the energy function.

First, the control-point calculating unit 14 determines, using the control weight information, whether the vertexes of the garment model should be included in the control points and, if the vertexes of the garment model are included in the control points, how λᵢ should be set in Expression 1 or Expression 6. If the control weight information is given, λᵢ can be set in advance. When the energy function in Expression 1 is used, the matrix A of Expression 2 is determined. Therefore, it is possible to calculate the matrix (A^{T}A)⁻¹A^{T} in Expression 5 beforehand.

On the other hand, when the control weight information is not included in the deformation parameters D3, after points corresponding to the human body model D2 are calculated by the Laplacian mesh method, λᵢ can be calculated. However, in this case, the matrix (A^{T}A)⁻¹A^{T} cannot be calculated beforehand. Therefore, processing after the acquisition of the human body model D2 takes time.

Subsequently, the control-point calculating unit 14 calculates corresponding points on the human body model D2 using the corresponding position information and calculates the target position coordinate cᵢ using the gap information. The control-point calculating unit 14 may calculate the value g of the gap taking into account a relation between the direction of the normal vector of the corresponding points of the human body model D2 and the direction of the gravity. Consequently, the matrix b in Expression 3 is determined and Expression 5 can be calculated.

On the other hand, when the corresponding position information is not included in the deformation parameters D3, it is also possible to adopt a method of three-dimensionally dividing a region and searching for corresponding points in a neighboring region using the Laplacian mesh method. However, in this case, computational complexity is large and time required for the calculation increases. When the gap information is not included in the deformation parameters D3, it is conceivable to not provide the gap or set a gap amount to a fixed value. However, accuracy of a simulation is deteriorated.

When the energy function shown in Expression 6 is used, μⱼ, that is, an importance level for maintaining the positional relation among the vertexes adjacent to the j-th vertex is calculated using the deforming flexibility information. If the deforming flexibility information is given, μⱼ can be set in advance and the matrix A shown in Expression 9 is determined. Therefore, the matrix (A^{T}A)⁻¹A^{T} shown in Expression 5 can be calculated beforehand. In this way, if the deforming flexibility information of the material of the garment is included in the deformation parameters D3, it is possible to simulate the deformation of the garment model D1 at higher accuracy.

On the other hand, when the deforming flexibility information is not included in the deformation parameters D3, μⱼ is set to a fixed value. Therefore, the accuracy of the simulation is slightly deteriorated.

According to the method described above, it is possible to define Expression 5 for each of combinations of the human body model D2 and the garment model D1 and calculate Expression 5.

### <Deformation Processing Unit>

The deformation processing unit 15 is described. The deformation processing unit 15 calculates a reaching position coordinate on the basis of the determined control points and the target position coordinates cᵢ of the control points to minimize a sum of absolute values of differences between the target position coordinates and the reaching position coordinates xᵢ, i.e., a sum obtained by taking into account importance levels of the points. Specifically, the deformation processing unit 15 executes calculation of Expression 5 completed by substituting the values. After the calculation, it is also possible to remove abnormal values and recalculate Expression 5 or calculate and correct a positional relation with the human body model at the vertexes of the garment model.

When the data processing method according to the embodiment described above is summarized, the data processing method is configured by procedures described below.

<1> A garment model representing the shape of a garment, deformation parameters representing characteristics of deformation of the garment, and a human body model representing the shape of a human body are acquired (steps S101 to S103).

<2> When the garment is worn on the human body and deformed, target position coordinates to which points of the garment model should move according to the human body are calculated (step S104).

<3> Reaching position coordinates are calculated to minimize a sum of absolute values of differences between the target position coordinates and reaching position coordinates where the points of the garment model reach, i.e., a sum obtained by taking into account importance levels of the points of the garment model (step S105).

### <<Image Forming Program>>

As described above, the data processing apparatus 1 according to the embodiment can be realized by causing a general-purpose computer to execute a computer program. A data processing program used in this case is a program for causing the computer to execute the procedures <1> to <3>.

### <<Effects of the First Embodiment>>

As described above, according to the embodiment, it is possible to simulate, on the basis of the human body model D2, the shape of the garment after the deformation obtained when the garment is virtually worn on the human body. Consequently, compared with the method of accumulating calculation results in advance, it is possible to obtain a highly accurate simulation result while suppressing prior processing costs.

According to the embodiment, it is possible to reduce a calculation time of Expression 5 by calculating the matrix (A^{T}A)⁻¹A^{T} beforehand and embedding a result of the calculation in the deformation parameters D3. Consequently, compared with the method by the physical simulation, it is possible to reduce an operation time after the human body model D2 is acquired. Further, it is possible to streamline the simulation by taking into account a portion not directly related to deformation such as a decoration portion in the garment and taking into account a relative positional relation with the human body according to a type of the garment.

### Second Embodiment

A second embodiment is described.

A data processing apparatus according to the embodiment is an apparatus for creating an animation (a moving image). In the data processing apparatus, a deformation history is stored after deformation of a garment model and used for deformation of the next frame. Consequently, it is possible to deform a garment following the movement of a human body and create a high-quality animation.

### <<Data Processing Apparatus>>

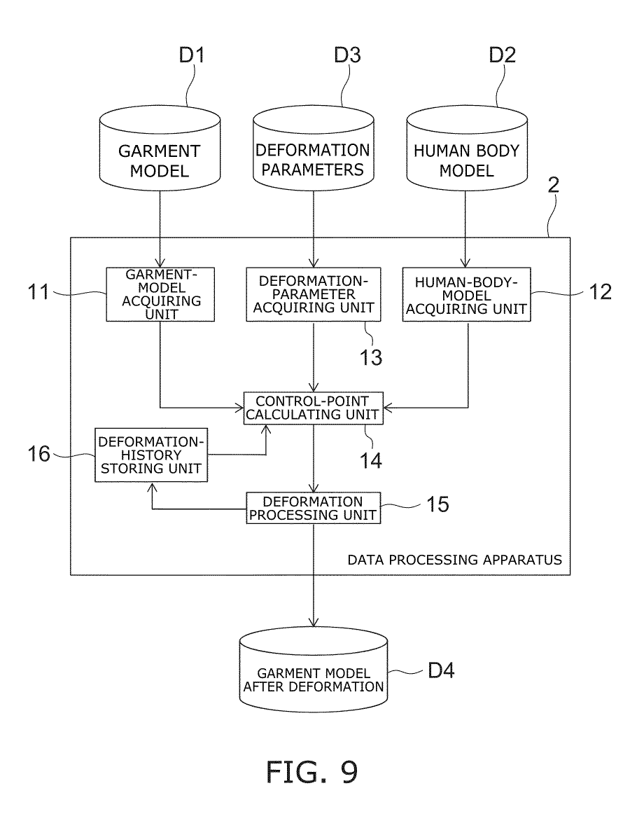

FIG. 9 is a block diagram illustrating the data processing apparatus according to the embodiment.

As shown in FIG. 9, in a data processing apparatus 2 according to the embodiment, a deformation-history storing unit 16 is provided in addition to the components of the data processing apparatus 1 (see FIG. 1) according to the first embodiment. The deformation-history storing unit 16 stores, as a change history, a result of a deformation simulation of the garment model D1 performed by the deformation processing unit 15. The deformation-history storing unit 16 can be configured by, for example, a RAM.

When the deformation simulation is performed at a first point in time and a second point in time later than the first point in time, at the second point in time, the control-point calculating unit 14 calculates target position coordinates Cᵢ at points of the garment model D1 taking into account a deformation history at the first point in time in addition to the garment model D1, the deformation parameters D3, and the human body model D2 at the second point in time.

Among components of the units, components different from the components in the first embodiment are described in detail below.

### <Deformation-History Storing Unit>

First, the deformation-history storing unit 16 is described.

The deformation-history storing unit 16 stores, as a deformation history, the garment model D4 after deformation calculated by the deformation processing unit 15. The deformation history includes, in addition to the garment model D4 after the deformation calculated by the deformation processing unit 15, the calculated matrix (A^{T}A)⁻¹A^{T} used by the control-point calculating unit 14 in deriving Expression 5, information concerning the corresponding points on the human body model at the control points used in deriving the matrix b described in Expression 3 or Expression 10, and information concerning the target position coordinate cᵢ after the deformation at the i-th control point. The control-point calculating unit 14 and the deformation processing unit 15 use these kinds of history information in performing processing of the next frame.

### <Control-Point Calculating Unit>

The control-point calculating unit 14 is described.

The control-point calculating unit 14 determines control points taking into account the deformation history read out from the deformation-history storing unit 16 in addition to the acquired garment model D1, deformation parameters D3, and human body model D2 and calculates target position coordinates after the deformation at the control points. The calculated matrix (A^{T}A)⁻¹A^{T} stored in the deformation-history storing unit 16 can be always reused. Therefore, the calculated matrix (A^{T}A)⁻¹A^{T} is reused in all frames.

The other deformation histories are classified into three patterns described below according to reuse methods for the deformation histories.

(1) A pattern for Reusing Both of the Information Concerning the Corresponding Points and the Target Position Coordinates

In this pattern, whereas continuity among the frames is satisfactorily kept, a risk of deviation of a result of processing same as the processing in the first embodiment from the result of the processing in the first embodiment is large.

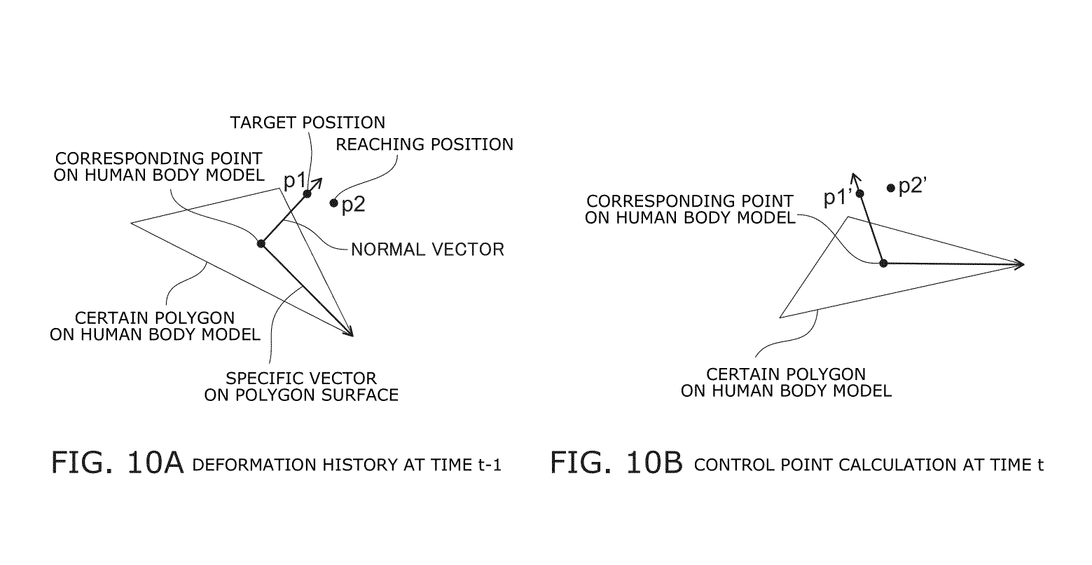

FIG. 10A is a diagram illustrating a deformation history at time (t−1). FIG. 10B is a diagram illustrating a control-point calculating method at time t.

Time (t−1) is time one frame before time t.

First, the reuse of a corresponding point of the human body model D2 corresponding to a control point in the garment model D1 is described with reference to FIGS. 10A and 10B. In this case, when a certain position in a certain polygon of the human body model D2 is set as a corresponding point at time (t−1), the same position of the same polygon is set as a corresponding point at time t.

Reuse of a target position coordinate of a control point of the garment model D1 is described. At time (t−1), a target position at a certain control point is represented as p1 and a reaching point is represented as p2. The target position p1 and the reaching position p2 are in a predetermined positional relation with respect to a polygon of the human body model, a normal vector, and a specific vector on a polygon surface at time (t−1). Subsequently, at time t, the control-point calculating unit 14 calculates a position p1′ and a position p2′, which are in the predetermined positional relation with respect to a polygon of the human body model, a normal vector, and a specific vector on a polygon surface at time t. The control-point calculating unit 14 sets the position p1′ or the position p2′ as a target position at time t. Simply by using the history of the frames in the past, it is possible to calculate Expression 5.

(2) A Pattern for Reusing Only the Information Concerning the Corresponding Points

In this pattern, whereas a result of processing same as the processing in the first embodiment is close to the result of the processing in the first embodiment, it is likely that the continuity among the frames is slightly broken. In this pattern, only the information concerning the corresponding points is reused. Thereafter, target position coordinates of the control points are calculated anew using the deformation parameters D3 as in the first embodiment. In this way, a part of the deformation histories is used and the remaining deformation histories are calculated anew. Consequently, it is possible to perform a simulation conforming to an actual state while securing a certain degree of the continuity.

(3) A Pattern for Not Reusing Both of the Information Concerning the Corresponding Points and the Target Position Coordinates

In this pattern, whereas a result of processing same as the processing in the first embodiment is equal to the result of the processing in the first embodiment, it is likely that the continuity among the frames is greatly broken. In this pattern, only the calculated matrix (A^{T}A)⁻¹A^{T} is reused. The other processing is the same as the processing in the first embodiment.

By performing the deformation processing while using the three patterns in a well-balanced manner, the continuity among the frames is kept and it is possible to realize a natural animation.

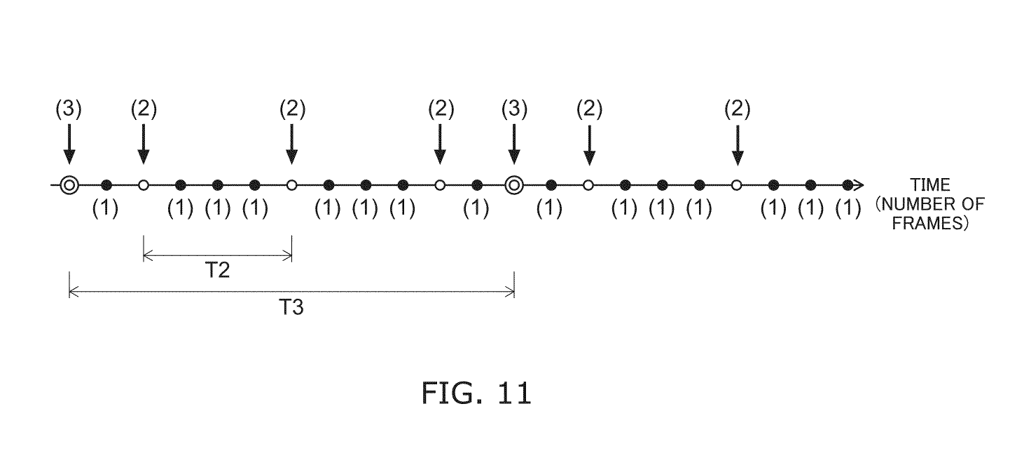

FIG. 11 is a time chart illustrating a data processing method according to the embodiment.

As shown in FIG. 11, for example, in a first frame and every time a fixed time (number of frames) T3 elapses thereafter, target position coordinates of the control points are calculated anew without inheriting the past deformation histories according to the pattern (3). Consequently, it is possible to guarantee accuracy of the simulation.

After the control points are calculated according to the pattern (3), every time a fixed time (number of frames) T2 elapses, the past deformation histories are partially inherited according to the pattern (2), a part of the deformation histories is calculated anew, and target position coordinates of the control points are calculated. The time T2 is shorter than the time T3.

In the frames in which the calculation by the pattern (3) and the pattern (2) is not performed, the past deformation histories are inherited and target position coordinates of the control points are calculated according to the pattern (1). Consequently, it is possible to keep the continuity among the frames.

In this way, by properly mixing and disposing the three kinds of patterns, while basically keeping the continuity among the frames, the recalculation using the deformation parameters is performed at a fixed interval and the garment model is corrected. As a result, it is possible to obtain a generally highly accurate result.

### <Deformation Processing Unit>

The deformation processing unit 15 is described. After forming the deformation simulation at time t, the deformation processing unit 15 may perform filtering in the time direction to correct the garment model using a deformation history before time (t−1). That is, the deformation processing unit 15 mixes a simulation result at time t and the deformation history before time (t−1) and creates a garment model at time t. For example, the deformation processing unit 15 performs the filtering according to Expression 12. Consequently, it is possible to further improve the continuity among the frames. In Expression 12, x′ₜ represents a reaching position coordinate after the correction at time t, xₜ represents a reaching position coordinate before the correction (after the normal deformation processing) at time t, r represents the number of frames in the past referred to in the filtering, and k represents an interpolation coefficient.

$${x}_{t}^{′} = k \frac{{\sum }_{i = 0}^{r - 1} {x}_{t - {i}^{′}}}{r} + ( 1 - k ) {x}_{t} \qquad Expression 12$$

A filtering method by Expression 12 is an example. General filtering in the time direction can also be used.

### <<Data Processing Method>>

The operation of the data processing apparatus 2, that is, a data processing method according to the embodiment is described.

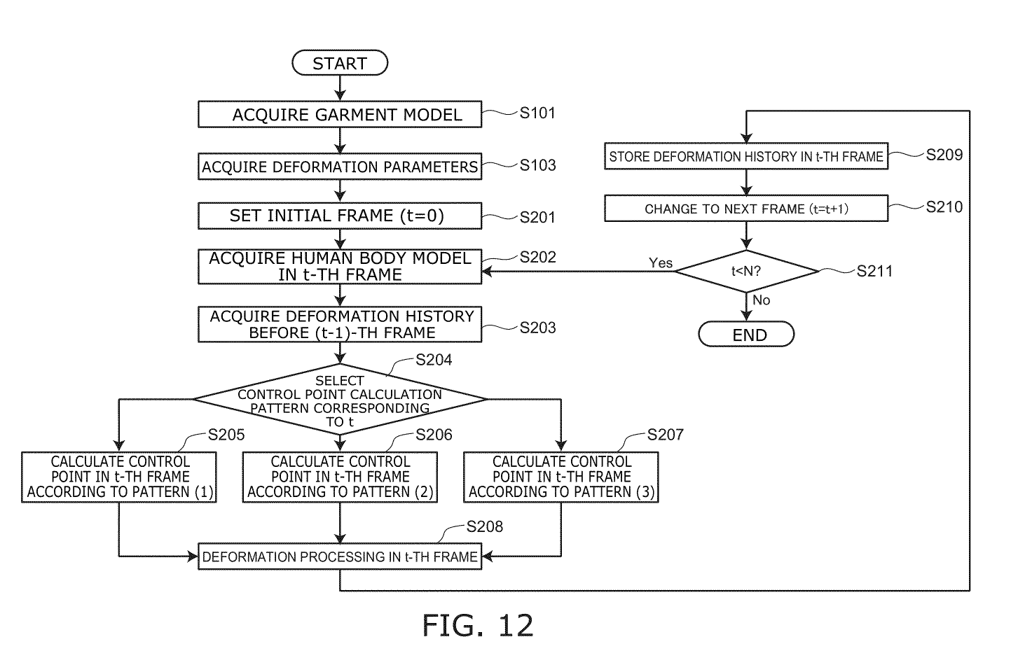

FIG. 12 is a flowchart illustrating the data processing method according to the embodiment.

In the embodiment, a plurality of frames arrayed in time series are present in the human body model D2.

First, as shown in step S101 in FIG. 12, the garment-model acquiring unit 11 acquires the garment model D1.

Subsequently, as shown in step S103, the deformation-parameter acquiring unit 13 acquires the deformation parameters D3.

As shown in step S201, the human-body-model acquiring unit 12 sets an initial frame, that is, sets a value of a time parameter t to 0.

As shown in step S202, the human-body-model acquiring unit 12 acquires the human body model D2 in a t-th frame.

As shown in step S203, the control-point calculating unit 14 acquires a deformation history before a (t−1)-th frame from the deformation-history storing unit 16. The deformation history before the (t−1)-th frame is data generated when deformation processing before the (t−1)-th frame is performed and stored in the deformation-history storing unit 16.

As shown in step S204 and FIG. 11, the control-point calculating unit 14 selects a control point calculation pattern corresponding to time t. That is, the control-point calculating unit 14 selects any one of the patterns (1) to (3). When the pattern (1) is selected, the processing proceeds to step S205. When the pattern (2) is selected, the processing proceeds to step S206. When the pattern (3) is selected, the processing proceeds to step S207.

In step S205, the control-point calculating unit 14 calculates control points in the t-th frame reusing both of the information concerning the corresponding points and the target position coordinates. The control-point calculating unit 14 determines the control points on the basis of the deformation history before the (t−1)-th frame besides the garment model D1, the deformation parameters D3, and the human body model D2 acquired in the t-th frame and calculates target position coordinates after deformation at the respective control points. Thereafter, the processing proceeds to step S208.

In step S206, the control-point calculating unit 14 determines control points in the t-th frame reusing the information concerning the corresponding points and calculates target position coordinates at the control points. Thereafter, the processing proceeds to step S208.

In step S207, the control-point calculating unit 14 determines control points in the t-th frame anew without reusing the past deformation history and calculates target position coordinates at the control points. Thereafter, the processing proceeds to step S208.

As shown in step S208, the deformation processing unit 15 performs the deformation processing in the t-th frame. The deformation-processing unit 15 performs the calculation of Expression 5 on the basis of the control points determined for the human body model D2 in the t-th frame and the target position coordinates after the deformation at the respective control points and calculates reaching position coordinates at the control points. As shown in step S209, the deformation processing unit 15 stores a deformation history in the t-th frame in the deformation-history storing unit 16.

As shown in step S210, the human-body-model acquiring unit 12 changes the frame to the next frame. That is, the human-body-model acquiring unit 12 changes the time parameter t to (t+1).

As shown in step S211, the human-body-model acquiring unit 12 determines whether the present frame reaches a last frame. A total number of frames of the human body model D2 is represented as N. The human-body-model acquiring unit 12 determines whether the present frame t reaches the last frame. If the present frame t reaches the last frame, that is, t=N, the processing ends. If the present frame t does not reach the last frame, that is, t<N, the processing returns to step S202.

By performing such processing, it is possible to simulate deformation of the garment model D1 for each of the frames with respect to the human body model D2 in which the plurality of frames are present. Consequently, it is possible to create an animation in which a garment is applied to a moving human body.

### <<Effects of the Second Embodiment>>

According to the embodiment, a deformation history of a garment model in a certain frame is stored in the deformation-history storing unit and used for a deformation simulation of the next garment model. Consequently, it is possible to create, at high speed and high accuracy, an animation of a garment model that follows the movement of a human body.

The present invention is not limited to the embodiments per se. The constituent elements can be changed and embodied without departing from the spirit of the present invention. Various inventions can be formed by appropriately combining the plurality of constituent elements disclosed in the embodiments.

For example, in the embodiments, the example is described in which the first object, which is the combining object, is the garment and the second object, which is the object to be combined, is the human body. However, the present invention is not limited to this. The first object only has to be an object that is deformed according to the shape of the second object. For example, the first object may be a cloth cover and the second object may be furniture or bedding.

In the embodiments, both of the first model and the second model target one kind of object. However, one or both of the first model and the second model may simultaneously target a plurality of kinds of objects.

Further, when a combining unit that combines the deformed first model and second model and a presenting unit that presents a combination result are added to the data processing apparatus according to the embodiments, it is possible to obtain a video combining apparatus for realizing VR representation of the combination result.

Furthermore, when a combining unit that combines the deformed garment D4 and human body image G2 and generates the combined image G3 (see FIG. 2) and a presenting unit that presents the combined image G3 are added to the data processing apparatus according to the embodiments, it is possible to obtain a video combining apparatus for realizing AR representation.

According to the embodiments described above, it is possible to realize the data processing apparatus and the data processing program capable of performing a low-cost and high-speed and highly accurate simulation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A data processing apparatus comprising:
a control-point calculating unit that calculates, on the basis of a first model representing a shape of a first object, deformation parameters representing characteristics of deformation of the first object, and a second model representing a shape of a second object, target position coordinates to which points of the first model should move according to the second model when the first object is deformed according to the second object; and
a deformation processing unit that calculates reaching position coordinates to minimize a sum of absolute values of differences between the target position coordinates and the reaching position coordinates where the point reaches, the sum being obtained by taking into account importance levels of the points.

2. The apparatus according to claim 1, wherein the deformation parameters include at least a part of calculation results capable of being calculated on the basis of the first model and the deformation parameters in a calculation formula used for calculating the reaching position coordinates.

3. The apparatus according to claim 1, wherein the deformation parameters include at least one of control weight information representing degrees of contribution of the points of the first model to the deformation of the first object, corresponding position information representing positions on the second model corresponding to the points of the first model, gap information representing distances between the target position coordinates and the second model, and deforming flexibility information representing a mechanical characteristic of the first object.

4. The apparatus according to claim 3, wherein the control weight information includes numerical values within a fixed range representing the degrees of the contribution of the points.

5. The apparatus according to claim 4, wherein, in the first model, the numerical value of a structural part is relatively high and the numerical value of an ornamental part is relatively low.

6. The apparatus according to claim 3, wherein the corresponding position information includes part IDs respectively attached to a plurality of parts forming the second model.

7. The apparatus according to claim 3, wherein the gap information includes absolute values or relative values of spacing amounts indicating distances by which the points of the first model are spaced from sections of the second model in a normal direction of the sections.

8. The apparatus according to claim 7, wherein
the second model includes both of a model representing the second object applied with a third object disposed between the second object and the first object and a model representing the second object not applied with the third object, and
the relative values are defined with reference to distances between points on a surface of the second object not applied with the third object and points on the surface of the second object applied with the third object.

9. The apparatus according to claim 3, wherein, in the first object, the distances are relatively short in a portion disposed above the second object and are relatively long in a portion disposed on a side of or below the second object.

10. The apparatus according to claim 3, wherein, when a plurality of kinds of the first objects are superimposed and applied on the second object, the distances are shorter in the first object disposed in a position closer to the second object.

11. The apparatus according to claim 3, wherein the deforming flexibility information includes at least one kind of characteristic of softness and an expansion and contraction degree of a material of the first object and at least one kind of allowable range of an allowable range of a change vector and an allowable range of a change amount before and after deformation between points adjacent to each other among the points of the first model.

12. The apparatus according to claim 1, wherein the deformation parameters are described in a texture format and associated with the points of the first model by performing texture mapping on the basis of texture coordinates set in the first model.

13. The apparatus according to claim 1, further comprising a deformation-history storing unit that stores the first model after the deformation as a change history, wherein
when calculating the target position coordinates at a second point in time later than a first point in time, the control-point calculating unit refers to the deformation history at the first point in time in addition to the first model, the deformation parameters, and the second model at the second point in time.

14. The apparatus according to claim 1, wherein the first object is a garment and the second object is a human body.

15. A data processing program for causing a computer to execute:
a procedure for calculating, on the basis of a first model representing a shape of a first object, deformation parameters representing characteristics of deformation of the first object, and a second model representing a shape of a second object, target position coordinates to which points of the first model should move according to the second model when the first object is deformed according to the second object; and
a procedure for calculating reaching position coordinates to minimize a sum of absolute values of differences between the target position coordinates and the reaching position coordinates where the point reaches, the sum being obtained by taking into account importance levels of the points.

16. The program according to claim 15, wherein the deformation parameters include at least a part of calculation results capable of being calculated on the basis of the first model and the deformation parameters in a calculation formula used for calculating the reaching position coordinates.

17. The program according to claim 15, wherein the deformation parameters include at least one of control weight information representing degrees of contribution of the points of the first model to the deformation of the first object, corresponding position information representing positions on the second model corresponding to the points of the first model, gap information representing distances between the target position coordinates and the second model, and deforming flexibility information representing a mechanical characteristic of the first object.

18. The program according to claim 17, wherein the control weight information includes numerical values within a fixed range representing the degrees of the contribution of the points.

19. The program according to claim 17, wherein the corresponding position information includes part IDs respectively attached to a plurality of parts forming the second model.

20. The program according to claim 15, wherein the first object is a garment and the second object is a human body.
